(19) United States
(12) Patent Application Publication
(10) Pub. No.: US 2012/0311228 A1
(43) Pub. Date: Dec. 6, 2012

(54) METHOD AND APPARATUS FOR PERFORMING MEMORY WEAR-LEVELING USING PASSIVE VARIABLE RESISTIVE MEMORY WRITE COUNTERS

(75) Inventors: Lisa Hsu, Kirkland, WA (US); Bradford M. Beckmann, Redmond, WA (US)

(73) Assignee: ADVANCED MICRO DEVICES, INC., Sunnyvale, CA (US)

(21) Appl. No.: 13/152,465

(22) Filed: Jun. 3, 2011

(51) Int. Cl. G06F 12/02

(52) U.S. Cl. 711/102; 711/E12.007

(57) ABSTRACT

Method and apparatus for performing wear-leveling using passive variable resistive memory (PVRM) based write counters are provided. In one example, a method for performing wear-leveling using passive PVRM based write counters is disclosed. The method includes associating a logical address of a memory array with a physical address of the memory array via at least one mapping table. Additionally, the method includes, in response to writing to the physical address of the memory array, incrementally updating at least one PVRM based write counter associated with the physical address of the memory array. The at least one PVRM based write counter may be incrementally updated by varying an amount of resistance stored in the at least one PVRM based write counter.

### FIELD OF THE DISCLOSURE

The present disclosure relates to a method and apparatus for performing memory wear-leveling.

### BACKGROUND OF THE DISCLOSURE

Wear-leveling is a technique for prolonging the useful lifetime of certain kinds of erasable computer storage media. For example, many classes of non-volatile memories (e.g., Flash, passive variable resistive memory (PVRM), etc.) are subject to wear-out, such that memory cells can become unreliable after a certain number of writes. The useful lifetime of a memory array can be even more drastically reduced from the ideal if the distribution of writes across the memory array is uneven over time.

Accordingly, techniques and systems for performing wear-leveling across a memory array have been developed in order to extend useful lifetimes of memory arrays. For example, in one technique, a pool of physical (as compared to logical) memory regions that have not been written to are tracked, such that any time a new write request is received, the write operation is directed to one of the free memory regions. In this manner, write operations may be spread throughout the physical memory regions of the memory array, to preclude any individual region from wear-out.

In another example, the number of writes that have been performed on each physical memory region are tracked. In this example, when a new write request is received, the write operation is directed to the physical memory region that has been written to the fewest number of times. In this manner, regions of memory that have been written to most frequently are protected from wear-out by funneling incoming writes to less-frequently written to memory regions.

Both of the preceding examples suffer from a number of drawbacks. For example, in each of the foregoing techniques, a table mapping arbitrary incoming logical addresses to physical addresses of the memory array is required for each region of the memory array. The need for such table(s) is undesirably costly from a space perspective and slows down the speed of the computing system due to the frequent need to access the mapping tables. Additionally, techniques that require tracking the number of writes to each physical region of the memory array are also undesirably costly from a space conservation perspective and tend to slow down the speed of such a computing system due to the need to identify the least-written to memory region. Furthermore, maintenance of such tables is costly from a power management perspective for many memory types.

Another existing technique for wear-leveling is called “Fine-grained wear-leveling.” Using fine-grained wear-leveling, a region rotation factor is generated for all regions in memory when they are paged in, as known in the art. Specifically, when a region is read into memory, a random value X is generated such that all lines within that region are shifted by X. Thus, line 0 becomes 0+X, while line 10 becomes 10+X. In this manner, writes to a region are distributed to different locations (i.e., lines) within that region. However, this technique undesirably relies on page-ins and page-outs to adjust mappings. Furthermore, there is no prevention of hot regions (i.e., regions that have been written to quite frequently), only hot lines within a given region are prevented.

Yet another existing technique that has been used to level the wear across a memory array is known as “Start-Gap Wear-Leveling.” Start-gap wear-leveling slowly rotates logical addresses throughout a physical memory array (i.e., dynamically associates a given logical address with a plurality of different physical addresses of the memory array), much like a circular buffer having a single temporary space, as known in the art. That is, using a start-gap wear-leveling technique, every N writes to memory, the temporary address is swapped with its neighbor, such that over time, the temporary space moves circularly through the address space. When the temporary space has made its way from the beginning to the end of the circular buffer, this effectively means that all addresses have been shifted by one spot. In order to avoid problems of locality from adjacent hot regions, this technique may introduce an invertible address randomization algorithm. An invertible address randomization algorithm may improve the start-gap wear-leveling technique by generating one-to-one mappings of logical addresses to physical addresses, such that adjacent hot regions are randomly strewn over the memory array's physical address space and temporary space shifts do not go from one hot region directly to another.

However, start-gap wear-leveling also suffers from a number of drawbacks. For example, computing systems utilizing start-gap wear-leveling must choose between two undesirable consequences in deciding when to move the “gap” (i.e., temporary space). The more frequently that the gap is moved, the less likely it becomes that any segment of the memory array will wear-out. However, frequently moving the gap comes at a great computational cost for the computing system because each time the gap is moved, the data stored in each physical address of the memory region including the gap must be moved in-kind. While infrequently moving the gap reduces the computational cost, it increases the likelihood that a segment of the memory array will wear out. Additionally, start-gap wear-leveling techniques are known to rely on statistical approximations to determine when a particular physical address is likely to become unreliable, and frequently utilize “just-in-time” shifts to re-map all of the logical addresses to different corresponding physical addresses whenever it is determined that a given physical address is on the verge of becoming unreliable (e.g., based upon the statistical analysis). However, start-gap wear leveling techniques that utilize these “just-in-time” shifts may be defeated by an application (sometimes referred to as an “adversarial application”) that bombards the heavily written physical address before the re-mapping is implemented.

Furthermore, conventional wear-leveling techniques are known to have additional drawbacks. For example, many conventional wear-leveling systems are only capable of tracking writes on a per-region basis, rather than a per-line basis. That is, conventional techniques are frequently unable to ascertain when a particular line within a region of a memory array has been written to enough times to make it unreliable. In addition, many wear-leveling techniques, such as those described above, decide to perform mapping shifts (i.e., associating a particular logical address with a different physical address) based on statistical estimations of when a particular region has been written to enough times to potentially make it unreliable. Stated another way, many existing wear-leveling systems decide when to perform a mapping shift based upon an educated guess.

Accordingly, a need exists for a method and apparatus designed to reduce the computational cost and speed associated with traditional wear-leveling techniques while simultaneously protecting against attacks by adversarial programs. Additionally, a need exists for a method and apparatus capable of performing wear-leveling, which utilizes a smaller amount of storage than existing technologies, yet does not require statistical approximations to determine when a re-mapping of logical and physical addresses should be performed.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting one example of an apparatus for performing memory wear-leveling using passive variable resistive write counters.

FIG. 2 generally depicts a horizontal mapping table and a diagram illustrating the association of certain logical and physical addresses of a memory array prior to a horizontal shift.

FIG. 3 generally depicts the horizontal mapping table of FIG. 2 and a diagram illustrating the association of certain logical and physical addresses of a memory array following a horizontal shift.

FIG. 4 generally depicts a vertical mapping table and a diagram illustrating the association of certain logical and physical addresses of a memory array prior to a vertical shift.

FIG. 5 generally depicts the vertical mapping table of FIG. 4 and a diagram illustrating the association of certain logical and physical addresses of a memory array following a vertical shift.

FIG. 6 generally depicts horizontal and vertical mapping tables and a diagram illustrating the association of certain logical and physical addresses of a memory array following both horizontal and vertical shifts according to the mapping tables.

FIG. 7 is a flowchart illustrating one example of a method for performing memory wear-leveling using passive variable resistive write counters.

FIG. 8 is a flowchart illustrating another example of a method for performing memory wear-leveling using passive variable resistive write counters.

### SUMMARY OF THE EMBODIMENTS

The present disclosure provides a method and apparatus for performing memory wear-leveling using passive variable resistive (PVRM) write counters. In one example, a method for performing memory wear-leveling using passive variable resistive write counters is disclosed. In this example, the method includes associating a logical address of a memory array with a physical address of the memory array via at least one mapping table. The method further includes, in response to writing to the physical address of the memory array, incrementally updating at least one PVRM based write counter associated with the physical address of the memory array by varying an amount of resistance stored in the at least one PVRM based write counter. In one example, the method additionally includes, in response to determining that the amount of resistance stored in the at least one PVRM based write counter exceeds a predetermined threshold, updating the at least one mapping table to associate the logical address of the memory array with a different physical address of the memory array. In yet another example, the method includes transferring data stored at the physical address of the memory array to the different physical address of the memory array based on the at least one mapping table.

The present disclosure also provides a related apparatus that may be used, for example, to carry out the above-method. In one example, the apparatus includes a memory array partitioned into a plurality of physical addresses, wherein each respective physical address is associated with a different logical address via at least one mapping table. In this example, the apparatus further includes at least one passive variable resistive memory (PVRM) based write counter associated with at least one physical address of the plurality of physical addresses of the memory array. The at least one PVRM based write counter is operative to store a varying amount of resistance, wherein the amount of resistance stored in the at least one PVRM based write counter indicates how many previous writes there have been to the at least one physical address. Continuing with this example, the apparatus additionally includes PVRM write counter update logic operatively connected to the memory array and the at least one PVRM based write counter. The PVRM write counter update logic is operative to incrementally update the at least one PVRM based write counter in response to the at least one physical address being written to. The PVRM based write counter update logic is operative to incrementally update the at least one PVRM based write counter by varying the amount of resistance stored in the at least one PVRM based write counter.

In one example of the above-described apparatus, the memory array includes the at least one PVRM based write counter. In another example, the apparatus further includes counter evaluation logic operatively connected to the memory array, wherein the counter evaluation logic is operative to determine whether the number of previous writes to the at least one physical address exceeds a predetermined threshold. In one example, the counter evaluation logic determines whether the number of previous writes to the at least one physical address exceeds a predetermined threshold by comparing the amount of resistance stored in the at least one PVRM based write counter associated with the at least one physical address with a predetermined threshold value stored in a register of the counter evaluation logic. In another example, the apparatus includes mapping table update logic operatively connected to the counter evaluation logic. In this example, the mapping table update logic is operative to update the at least one mapping table in response to a determination by the counter evaluation logic that the number of previous writes to the at least one physical address exceeds the predetermined threshold. In yet another example, the mapping table update logic is operative to update the at least one mapping table by changing the physical address associated with a particular logical address.

In still another example, the apparatus includes data transfer logic operatively connected to the memory array. In this example, the data transfer logic is operative to instruct the memory array to transfer data stored at a first physical address of the plurality of physical addresses of the memory array to a second physical address of the plurality of physical addresses of the memory array based on the at least one mapping table.

In one example, each physical address of the memory array identifies a line of a plurality of lines within a region of the memory array. In this example, the at least one PVRM based write counter associated with the at least one physical address includes at least one of a PVRM based line write counter and a PVRM based region write counter. In one example, the PVRM based line write counter is operative to store a varying amount of resistance, wherein the amount of resistance stored in the PVRM based line write counter indicates a number of previous writes to the line at the at least one physical address that the PVRM based line write counter is associated with. In another example, the PVRM based region write counter is operative to store a varying amount of resistance, wherein the amount of resistance stored in the PVRM based region write counter indicates a number of previous writes to all lines of the plurality of lines within the region including the at least one physical address that the PVRM based region write counter is associated with.

Finally, the present disclosure provides apparatuses in the form of memory cells, where each memory cell is operative to store multiple bits. In one example of such an apparatus, the apparatus includes a single (i.e., one) memory cell operative to store a plurality of bits. In this example, the plurality of bits indicate a physical address write-value. The physical address write-value indicates an amount of writes that have been performed to a physical address of a memory array. That is to say, the physical address write-value indicates the number of write operations that have been performed to a physical address of a memory array.

In another example, an apparatus includes a single multi-bit memory cell associated with a line within a region of a memory array. In this example, the single multi-bit memory cell is operative to store a plurality of bits indicating a line write-value. The line write-value indicates an amount of writes that have been performed to the line associated with the single multi-bit memory cell. In one example, the single multi-bit memory cell comprises a memristor.

In yet another example, an apparatus includes a memory array comprising at least one region, each at least one region comprising a plurality of lines. The apparatus further includes a first multi-bit memory cell associated with a line of the plurality of lines within a given region of the memory array. The first multi-bit memory cell is operative to store a plurality of bits indicating a line write-value. The line write-value indicates an amount of writes that have been performed to the line associated with the first multi-bit memory cell. The apparatus also includes a second multi-bit memory cell associated with at least one region of the memory array. The second multi-bit memory cell is operative to store a plurality of bits indicating a region write-value. The region write-value indicates an amount of writes that have been performed to the at least one region associated with the second multi-bit memory cell.

Among other embodiments, the present disclosure provides a method and apparatus for performing wear-leveling using passive variable resistive (PVRM) based write counters capable of measuring the number of writes to both a region and a line within a memory array. Furthermore, the analog nature of the PVRM write counters allows for a single PVRM cell (e.g., a memristor cell) to serve as a multi-bit counter for tracking the amount of wear to a line/region of a memory array. By tracking the wear to a memory array with such fine granularity, mapping shifts may be performed when they are actually needed (as opposed to when they are thought to be needed based upon a statistical estimation) in order to both (1) evenly distribute wear across the memory array and (2) protect against adversarial programs that may otherwise wear out an area of a memory array. Additionally, new techniques for mapping logical addresses to physical addresses are provided. Other advantages will be recognized by those of ordinary skill in the art.

### DETAILED DESCRIPTION OF THE EMBODIMENTS

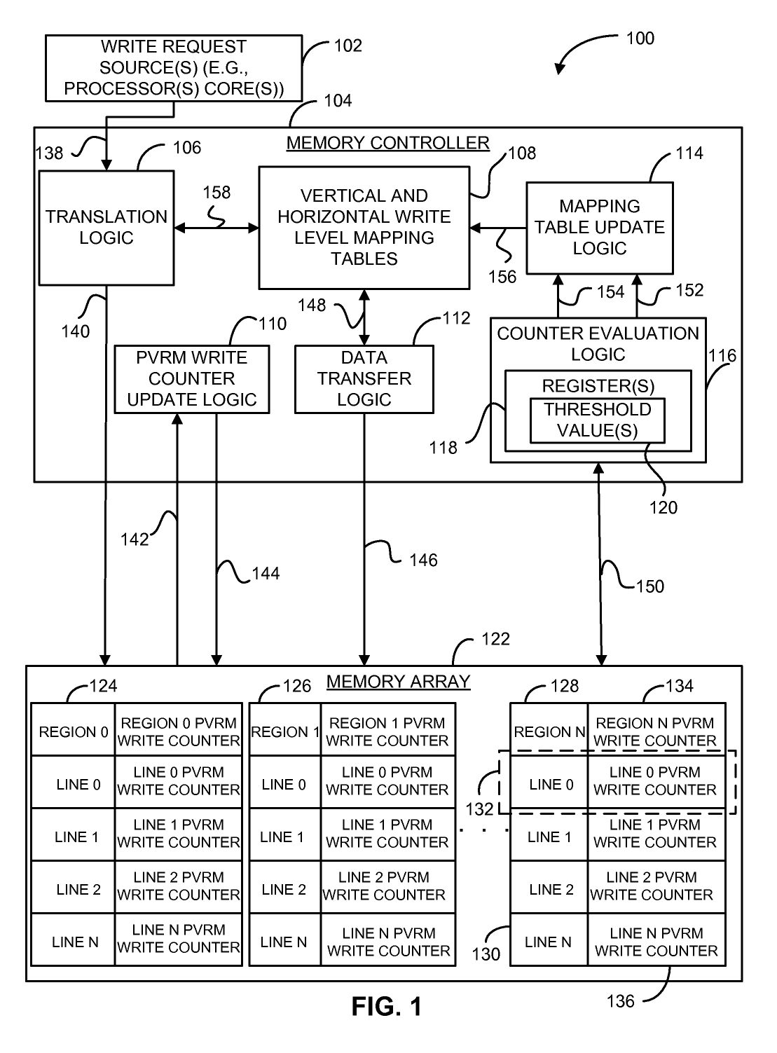

The following description of the embodiments is merely exemplary in nature and is in no way intended to limit the disclosure, its application, or uses. FIG. 1 illustrates one example of an apparatus 100 for performing wear-leveling using passive variable resistive (PVRM) write counters in accordance with the present disclosure. In one example, the PVRM may comprise any one of phase-change memory, spin-torque transfer magnetoresistive memory, memristor memory, or any other suitable form of non-volatile passive variable resistive memory. The apparatus 100 may exist, for example, in a personal computer (e.g., a desktop or laptop computer), personal digital assistant (PDAs), personal video recorder (PVR), television, cellular telephone, tablet (e.g., an Apple® iPad®), one or more networked computing devices (e.g., server computers or the like, wherein each individual computing device implements one or more functions of the apparatus 100), camera, or any other suitable electronic device.

PVRM is a broad term used to describe any memory technology that stores state in the form of resistance instead of charge. That is, PVRM technologies use the resistance of a cell to store the state of a bit, in contrast to charge-based memory technologies that use electric charge to store the state of a bit. PVRM is referred to as being passive due to the fact that it does not require any active semiconductor devices, such as transistors, to act as switches. These types of memory are said to be “non-volatile” due to the fact that they retain state information following a power loss or power cycle. Passive variable resistive memory is also known as resistive non-volatile random access memory (RNVRAM or RRAM).

Examples of PVRM include, but are not limited to, Ferroelectric RAM (FeRAM), Magnetoresistive RAM (MRAM), Memristors, Phase Change Memory (PCM), and Spin-Torque Transfer MRAM (STT-MRAM). While any of these technologies may be suitable for use in conjunction with an apparatus, such as the apparatus 100 disclosed herein, PCM, memristors, and STT-MRAM are contemplated as providing an especially nice fit and are therefore discussed below in additional detail.

Phase change memory (PCM) is a PVRM technology that relies on the properties of a phase change material, generally chalcogenides, to store state. Writes are performed by injecting current into the storage device, thermally heating the phase change material. An abrupt shutoff of current causes the material to freeze in an amorphous state, which has high resistivity, whereas a slow, gradual reduction in current results in the formation of crystals in the material. The crystalline state has lower resistance than the amorphous state; thus a value of 1 or 0 corresponds to the resistivity of a cell. Varied current reduction slopes can produce in-between states, allowing for potential multi-level cells. A PCM storage element consists of a heating resistor and chalcogenide between electrodes, while a PCM cell is comprised of the storage element and an access transistor.

Memristors are commonly referred to as the “fourth circuit element,” the other three being the resistor, the capacitor, and the inductor. A memristor is essentially a two-terminal variable resistor, with resistance dependent upon the amount of charge that passed between the terminals. Thus, a memristor's resistance varies with the amount of current going through it, and that resistance is remembered even when the current flow is stopped. One example of a memristor is disclosed in corresponding U.S. Patent Application Publication No. 2008/0090337, having a title “ELECTRICALLY ACTUATED SWITCH”, which is incorporated herein by reference.

Spin-Torque Transfer Magnetoresistive RAM (STT-MRAM) is a second-generation version of MRAM, the original of which was deemed “prototypical” by the International Technology Roadmap for Semiconductors (ITRS). MRAM stores information in the form of a magnetic tunnel junction (MTJ), which separates two ferromagnetic materials with a layer of thin insulating material. The storage value changes when one layer switches to align with or oppose the direction of its counterpart layer, which then affects the junction's resistance. Original MRAM required an adequate magnetic field in order to induce this change. This was both difficult and inefficient, resulting in impractically high write energy. STT-MRAM uses spin-polarized current to reverse polarity without needing an external magnetic field. Thus, the STT technique reduces write energy as well as eliminating the difficult aspect of producing reliable and adequately strengthen magnetic fields. However, STT-MRAM, like PCM, requires an access transistor and thus its cell size scaling depends on transistor scaling.

In any event, the apparatus includes one or more write request sources 102. The one or more write request sources 102 may include, for example, one or more processors, each processor having one or more cores. In one example, the write request source(s) 102 include a CPU and/or GPU. The write request source(s) 102 are operatively connected to a memory controller 104 over a suitable communication channel, such as a bus. The memory controller 104 may include, for example, a digital circuit operative to manage the flow of data going to and from the memory array 122 as known in the art. Although depicted as being separate from the one or more write request sources 102, it is recognized that in some embodiments, the memory controller 104 may be integrated into another chip, such as a processor chip serving as a write request source 102.

In one example, the memory controller 104 includes translation logic 106, vertical and horizontal write level mapping tables 108, PVRM write counter update logic 110, data transfer logic 112, mapping table update logic 114, and counter evaluation logic 116. Although components 106-116 are depicted as being part of the memory controller 104 in this example, it is recognized that any or all of these components may be suitably implemented as discrete components separate from the memory controller 104 as desired. For instance, although counter evaluation logic 116 is illustrated as being part of the memory controller 104, in one example, the counter evaluation logic may reside within the memory array 122 as a matter of design choice.

The translation logic 106 may include, for example, any suitable combination of hardware (e.g., one or more microprocessors, microcontrollers, digital signal processors, or combinations thereof operating under the control of executable instructions stored in the storage component) and/or software capable of carrying out the functionality described herein. Similarly, the PVRM write counter update logic 110, the data transfer logic 112, the mapping table update logic 114, and the counter evaluation logic 116 may each include, for example, any suitable combination of hardware (e.g., one or more microprocessors, microcontrollers, digital signal processors, or combinations thereof operating under the control of executable instructions stored in the storage component) and/or software capable of carrying out the functionality described herein. In one example, the vertical and horizontal write level mapping tables 108 may be stored in a storage component (e.g., memory) of the memory controller 104. In another example, the vertical and horizontal write level mapping tables 108 may be stored in memory that is separate from the memory controller 104. In one example, the counter evaluation logic 116 includes one or more registers 118. The one or more registers 118 are operative to store one or more threshold values 120, as discussed in further detail below.

The memory controller 104 of the apparatus 100 is operatively connected to the memory array 122 over one or more suitable communication channels, such as one or more buses. The memory array 122 may include any suitable type of volatile/non-volatile memory components such as, but not limited to, read-only memory (ROM), random access memory (RAM), electrically erasable programmable read-only memory (EE-PROM), Flash, PVRM, etc., or combinations thereof. As known in the art, the memory array 122 is partitioned into a plurality of regions, such as region (0) 124, region (1) 126, and region (N) 128. As indicated by the ellipsis between region (1) 126 and region (N) 128, the memory array 122 may be partitioned into as many regions as desired. Each region (e.g., region (N) 128) is further partitioned into a plurality of lines, such as line (N) 130. In one example, the number of lines in each region are equal to the total number of regions of the memory array 122. Additionally, each line within each region (e.g., line (N) 130 of region (N) 128) corresponds to a physical address 132 of the memory array. As will be discussed in greater detail below, each physical address (e.g., physical address 132 corresponding to line (0) of region (N)) is associated with a logical address via the vertical and horizontal write level mapping tables 108.

Furthermore, in one example, the memory array 122 includes a plurality of PVRM based write counters, such as region (N) PVRM based write counter 134 and line (N) PVRM based write counter 136. Although the plurality of PVRM based write counters are depicted as being part of the memory array 122, it is recognized that in some embodiments the PVRM based write counters may be arranged separately from the memory array 122 within the apparatus 100. Each PVRM based write counter may include any suitable type of PVRM, such as the types of PVRM described above. In one example, each PVRM based write counter is a memristor cell.

Each PVRM based write counter is associated with at least one physical address (e.g., physical address 132) of the memory array 122. For example, regional PVRM based write counters (e.g., region (N) PVRM based write counter 134) may be associated with a plurality of physical addresses. For example, each regional PVRM based write counter (e.g., region (N) PVRM based write counter 134) is operative to track the total number of write operations that have been performed on all of the lines within that region (e.g., the total number of write operations that have been performed on lines (0) through (N) of region (N)). Similarly, each PVRM based line write counter (e.g., line (N) PVRM based write counter 136) is operative to track the total number of writes to the line that each respective PVRM based line write counter is associated with. By way of example, line (N) PVRM based write counter 136 is operative to track the total number of writes to line (N) 130 of region (N) 128.

The PVRM based write counters (either region write counters or line write counters) are operative to track the number of writes that have been performed to a particular region/line by storing varying amounts of resistance. For example, each PVRM based write counter may include a memristor cell. As known in the art, a memristor cell may store a varying amount of resistance. The amount of resistance stored in a memristor cell at any given time may be varied, for example, by applying a current across the memristor cell as known in the art. In one embodiment, for example, the amount of resistance stored in a PVRM based write counter may be incrementally increased by applying a current across the memristor cell each time that a write operation has been performed to the line/region that the PVRM based write counter is tracking.

In this manner, the amount of resistance stored in a PVRM based write counter at any particular time may indicate the number of write operations that have been performed on the line/region of the memory array that the PVRM based write counter is associated with (i.e., tracking). PVRM based write counters are particularly advantageous, when compared to prior art write counters for example, in that a single PVRM based write counter (e.g., one memristor cell) can store a wide range of values. That is to say, each PVRM based write counter effectively functions as an analog device capable of tracking the number of writes to a particular line/region of the memory array. Stated yet another way, using a PVRM based write counter such as a memristor, a single bit may serve effectively as a multi-bit counter for the number of write operations that have been performed on a given line/region.

However, the present disclosure also recognizes that multiple memristor bits may be used to track, for example, the number of writes to a single line or single region of a memory array in order to achieve the desired precision. For example, if the functional range of a PVRM based write counter is from 0 ohms to N ohms, and functionally, the granularity of resistance to be added is N/D ohms, then the single PVRM based write counter can effectively model a traditional binary counter of log₂(D) bits. If the desired counter width is greater than log₂(D) bits, then another PVRM based write counter may be required.

In one example, the apparatus 100 operates as follows. The write request source(s) 102 generate one or more write requests, such as write request 138, which are received by the translation logic 106 of the memory controller 104. A write request 138 identifies a logical address to be written to, along with data values to be stored at the physical address associated with the identified logical address. In response to receiving the write request 138, the translation logic 106 is operative to translate the identified logical address into a physical address (e.g., physical address 132 of the memory array 122). The translation logic 106 is operative to translate the logical address into a physical address based on the vertical and horizontal write level mapping tables 108. For example, the translation logic 106 obtains mapping table association information 158 from the vertical and horizontal write level mapping tables 108, which specifies a particular physical address that is associated with the logical address identified in the write request 138.

After translating the logical address identified in the write request 138 into a physical address of the memory array, the physical address of the memory array (e.g., physical address 132) is written to using techniques known in the art. Following execution of the write operation, write confirmation information 142 is obtained by the PVRM write counter update logic 110 of the memory controller 104. The write confirmation information 142 identifies the physical address that was written to. In response to receiving the write confirmation information 142, the PVRM write counter update logic 110 is operative to update the PVRM based write counter associated with the physical address of the memory array that was written to. For example, the PVRM write counter update logic 110 is operative to update the PVRM based write counter by varying the amount of resistance stored in the PVRM write counter. In one example, the PVRM write counter update logic 110 is operative to vary the amount of resistance stored in the PVRM based write counter by applying a current across the PVRM based write counter, using techniques known in the art.

By way of example, the write request 138 may identify a logical address associated with physical address 132 (which association is governed by the vertical and horizontal write level mapping tables 108). Consequently, line (0) of region (N) may be written to, as line (0) of region (N) corresponds to physical address 132. Write confirmation information 142 may then be obtained by the PVRM write counter update logic 110 indicating that physical address 132 was written to. Accordingly, PVRM write counter update logic 110 may generate PVRM write counter update information 144 operative to update the one or more PVRM based write counters associated with physical address 132. Continuing with this example, PVRM write counter update information 144 may update region (N) PVRM write counter 134 (because physical address 132 is located within region (N)) and line (0) PVRM write counter (because line (0) of region (N) corresponds to physical address 132).

As noted above, each PVRM based write counter is operative to track to the number of writes to a particular line/region of the memory array 122. In order to ensure that any particular line/region does not become unreliable (i.e., “worn-out”) due to an excessive number of writes, one or more threshold values (e.g., threshold value(s) 120) may be set for each line/region in accordance with one aspect of the apparatus 100. The threshold values 120 indicate the maximum number of write operations that may be performed to a given line/region of memory before it is necessary to change the association between incoming logical addresses (e.g., the logical addresses identified by the write requests 138) and physical addresses of the memory array. The vertical and horizontal write level mapping tables 108 may be updated in order to affect the new association, as described below.

Counter evaluation logic 116 is operative to determine whether the number of previous writes to a given line (corresponding, for example, to one physical address of the memory array) or a given region (corresponding, for example, to a plurality of physical addresses of the memory array) exceeds a predetermined threshold value associated with the given line or given region. In one example, the counter evaluation logic 116 is operative to determine whether the number of writes to a given line or region exceeds the predetermined threshold value associated with that line or region by comparing the amount of resistance stored in the PVRM based write counter associated with the line or region with a predetermined threshold value associated with the line or region.

For example, following a write operation to a given physical address (e.g., physical address 132), counter evaluation logic 116 obtains PVRM write counter resistance information 150. In this example, the PVRM write counter resistance information 150 identifies the amount of resistance stored in line (0) PVRM write counter (which is indicative of the number of previous writes to line (0) of region (N)) and/or the amount of resistance stored in region (N) PVRM write counter (which is indicative of the total number of writes to each line in region (N)). While the present disclosure typically discusses the apparatus 100 as keeping track of the number of writes to both a line and a region of the memory array, it is recognized that in some embodiments, the apparatus 100 may only track writes to a line, or writes to a region, but not both. For example, when functioning in an embodiment where only writes to lines are tracked, apparatus 100 need not include regional PVRM based write counter (e.g., region (N) PVRM based write counter 134).

In any case, after obtaining the PVRM write counter resistance information 150, the counter evaluation logic 116 is operative to compare the resistance information 150 with one or more threshold values 120. For example, when PVRM write counter resistance information 150 includes information indicating the amount of resistance stored in both a PVRM based line write counter (e.g., line (N) PVRM based write counter 136) and a PVRM based region write counter (e.g., region (N) PVRM based write counter 134), counter evaluation logic 116 is operative to compare the amount of resistance stored in the PVRM based line write counter with one associated threshold value and the amount of resistance stored in the PVRM based region write counter with another associated threshold value. Of course, in one example, the threshold value associated with the PVRM based line write counter and the threshold value associated with the PVRM based region write counter may be the same. Furthermore, in one example, the threshold value(s) 120 are stored in a register 118 of the counter evaluation logic 116. However, it is recognized that the threshold value(s) 120 could be stored in any suitable storage component known in the art.

If the counter evaluation logic 116 determines that the number of writes to given line/region of the memory array 122 has met or exceeded the threshold value associated with that line/region, then the counter evaluation logic 116 is operative to generate threshold attainment information (e.g., region re-mapping threshold information 152 and/or line re-mapping threshold information 154). For example, upon determining that the number of writes to a particular region has exceeded the threshold value associated with that region, the counter evaluation logic 116 is operative to generate region re-mapping threshold information 152 identifying that region. Similarly, upon determining that the number of writes to a particular line has exceeded the threshold value associated with that line, the counter evaluation logic 116 is operative to generate line re-mapping threshold information 154 identifying that line (e.g., line (N) of region (N) 130).

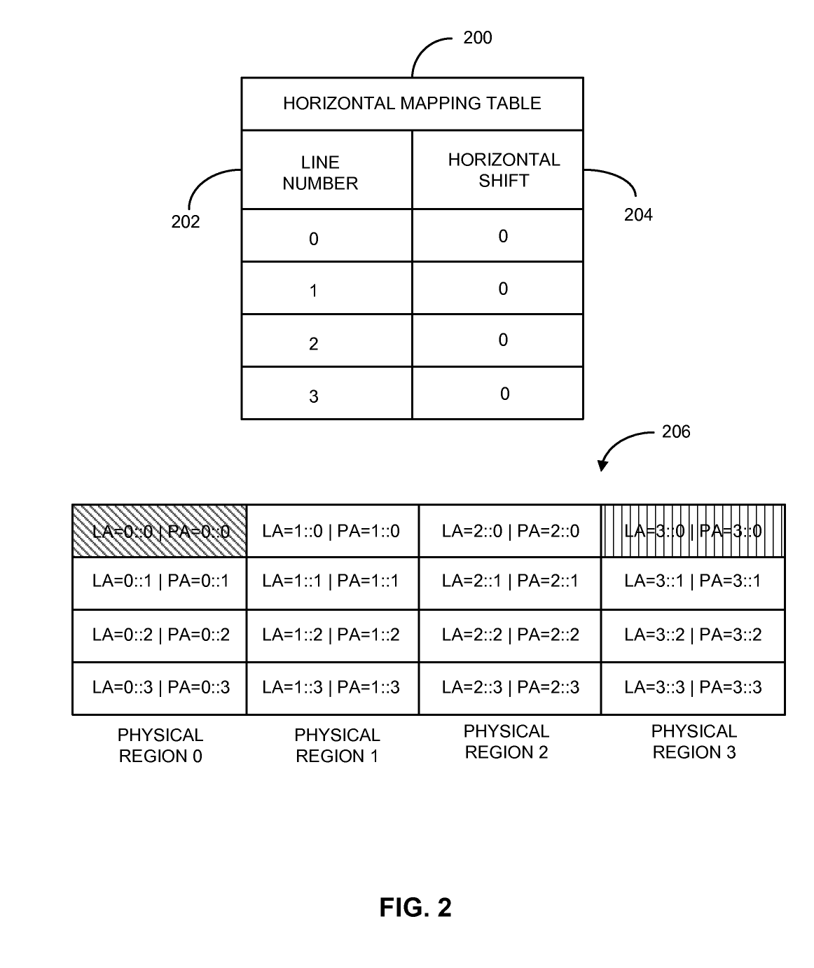

The re-mapping threshold information 152, 154 is provided to mapping table update logic 114 over one or more suitable communication channels, such as one or more buses. Mapping table update logic 114 is operative to update at least one mapping table (e.g., horizontal and/or vertical write level mapping tables) in response to receiving the re-mapping threshold information 152, 154. For example, mapping table update logic is operative to generate mapping table(s) update information 156, which may be provided to the vertical and horizontal write level mapping tables 108. The particular scheme that is used to generate the mapping table(s) update information 156 is a matter of design choice, as will be discussed in additional detail with respect to FIGS. 2-6 below.

After the vertical and/or horizontal write level mapping tables 108 have been updated, data transfer logic 112 is operative to obtain mapping table(s) update information 148. The mapping table(s) update information 148 includes information identifying a new association between one or more logical address and one or more physical address of the memory array 122. For example, after updating the vertical and horizontal write level mapping tables 108, a given logical address may become associated with a different physical address than it was associated with prior to the update. The mapping table(s) update information 148 describes the new association. In response to obtaining the mapping table(s) update information 148, the data transfer logic 112 is operative to generate data transfer instruction information 146 to the memory array 122 over one or more suitable communication channels, such as one or more buses. The data transfer instruction information 146 is operative to instruct the memory array 122 to transfer data stored at a first physical address of the memory array (e.g., physical address 132) to a second physical address of the memory array (e.g., the physical address associated with line (0) of region (0) of the memory array 122). Where the data is transferred from, and where the data is transferred to, is based upon the vertical and horizontal write level mapping tables 108 (i.e., the mapping table(s) update information 148 indicating the logical-to-physical address associations set forth in the mapping tables 108).

Referring now to FIG. 2, a horizontal write level mapping table 200 and a diagram 206 illustrating the association of certain logical and physical addresses of a memory array prior to a horizontal shift are illustrated. A horizontal write level mapping table, such as horizontal mapping table 200, may be included as part of the vertical and horizontal write level mapping tables 108 described above. The horizontal mapping table 200 includes a line number column 202 and a horizontal shift number column 204. The line number column 202 identifies all of the lines in each region of a memory array, such as memory array 122 described above. The diagram 206 of FIG. 2 only illustrates four lines in four regions for purposes of simplicity, however, it is recognized that the concepts described herein apply equally well to a memory array having any suitable number of lines and regions.

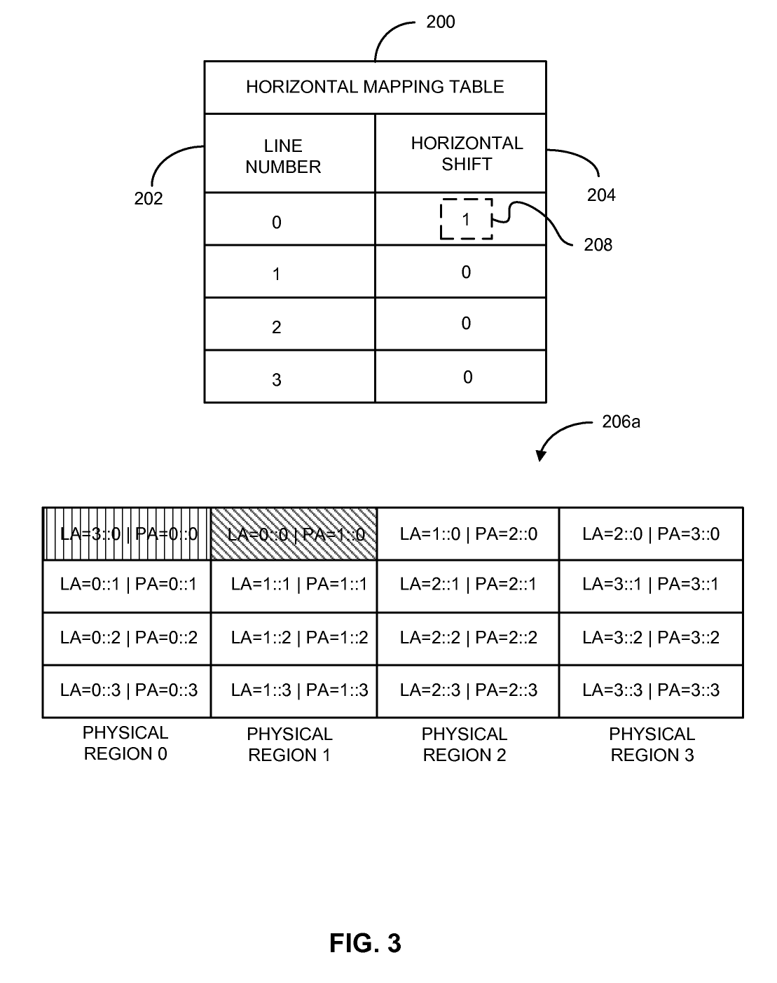

The horizontal shift column 204 identifies how the association between certain logical addresses and physical addresses should change based upon a determination (e.g., by counter evaluation logic 116) that a particular line in the memory array has been written to a predetermined number of times (i.e., met or exceeded its corresponding threshold value). With continued reference to FIG. 2, horizontal mapping table 200 is depicted in an initialization state without any horizontal shift numbers assigned to any of the line numbers of the line number column 202. Of course, in certain embodiments, there may be horizontal shift numbers assigned to any or all of the line numbers during initialization as a matter of design choice. In any event, diagram 206 depicts the association of logical addresses to physical addresses for four different physical regions of a memory array (i.e., physical regions 0-3). For example, with reference to the cell in the upper left-hand corner of diagram 206, the cell notes “LA=0::0|PA=0::0”. This is intended to demonstrate that, in this state, the logical address (“LA”) at region (0) and line (0) (“0::0”) is associated with the physical address (“PA”) at region (0) and line (0) (“0::0”). In order to trace the re-mapping (i.e., re-association) of certain logical addresses, the cell corresponding to logical address 0::0 is illustrated as having a diagonal cross-hatch in both FIGS. 2-3. By contrast, and with reference to the cell in the upper right-hand corner of diagram 206, the cell notes “LA=3::0|PA=3::0”. This is intended to demonstrate that, in this state, the logical address (“LA”) at region (3) and line (0) (“3::0”) is associated with the physical address (“PA”) at region (3) and line (0) (“3::0”). The cell corresponding to logical address 3::0 is illustrated as having a vertical cross-hatch in both FIGS. 2-3.

FIG. 3 generally depicts an updated version of the horizontal mapping table 200 of FIG. 2 and a diagram 206a illustrating an updated association between certain logical and physical addresses of a memory array following a horizontal shift. For example, the horizontal mapping table 200 and diagram 206 of FIG. 2 may be thought of as corresponding to an initial state of the apparatus 100, before the amount of resistance stored in any PVRM based write counter exceeds its corresponding threshold value (as determined, for example, by the counter evaluation logic 116). Conversely, the horizontal mapping table 200 and diagram 206a of FIG. 3 may be thought of as corresponding to a subsequent state of the apparatus 100, following a determination that the amount of resistance stored in a line PVRM based write counter exceeds its corresponding threshold value.

The updated mapping table 200 and diagram 206a depicted in FIG. 3 can be arrived at from the mapping table 200 and diagram 206 shown in FIG. 2 in the following manner. As discussed above, FIG. 2 illustrates an initialization state in order to show how the present apparatus 100 may re-map certain logical addresses to different physical addresses in order to perform wear-leveling and mitigate adversarial attacks. Thus, in order to simplify the discussion, consider an example where the apparatus 100 is a computing device including a memory array 122 that has not been written to.

Accordingly, at this stage (and by way of example only) each incoming logical address may be associated with the exact same physical address via the vertical and horizontal write level mapping tables 108. That is to say, at this stage, all of the horizontal shift numbers corresponding to each of the line numbers shown in the horizontal mapping table 200 would be zero (as is the case in FIG. 2). This is the situation shown in FIG. 2.

Eventually, a given line with a physical region of the memory array will be written to enough times that it will reach its threshold (as determined, for example, by the counter evaluation logic 116 in accordance with its above-described functionality). When a given line (e.g., line (0) of region (0)) has been written to enough times to meet or exceed the threshold value associated with that line, the apparatus 100 is operative to change the association between all logical address at the same line as the line that had been written to enough times to meet or exceed the threshold value associated with that line. This concept is best illustrated with respect to FIG. 3.

FIG. 3 illustrates an exemplary situation where one of the physical addresses at line (0), in any region of the memory array 122, had been written to enough times to meet or exceed the threshold value associated with that physical address. Accordingly, mapping table update logic 114 generated mapping table(s) update information 156 operative to update horizontal mapping table 200. Specifically, the mapping table(s) update information 156 updated the horizontal mapping table 200 to change the horizontal shift number 208 associated with line (0) from zero to one. This has the effect of changing the association of all logical and physical addresses at line (0), across all regions of the memory array 122. Specifically, by changing the horizontal shift number 208 associated with line (0) from zero to one, each logical address at line (0) becomes associated with a different physical address at line (0).

For example, logical address 0::0 was originally associated with physical address 0::0 as shown in FIG. 2. However, following the mapping table update, logical address 0::0 becomes associated with physical address 1::0 as shown in FIG. 3. Similarly, logical address 3::0 was originally associated with physical address 3::0 as shown in FIG. 2. However, following the mapping table update, logical address 3::0 becomes associated with physical address 0::0 as shown in FIG. 3. Thus, as shown in FIG. 3, each logical address corresponding to line (0) has been re-mapped to a physical address one region over from its original mapping. The horizontal shift number 208 describes how many regions over the new physical address associated with each logical address at line (0) should be. While the horizontal shift number 208 associated with line (0) is illustrated as being one in FIG. 3, it is appreciated that this number (and thus, the distance of the “shift”) may be selected as desired. For example, in one embodiment it is conceivable that the horizontal shift number for any line could be three rather than one (meaning that each logical address would become associated with a physical address having the same line number, but three regions over). Additionally, in one example, the horizontal shift number may be incremented each time that it is determined that any physical address at the appropriate line has been written to the threshold number of times.

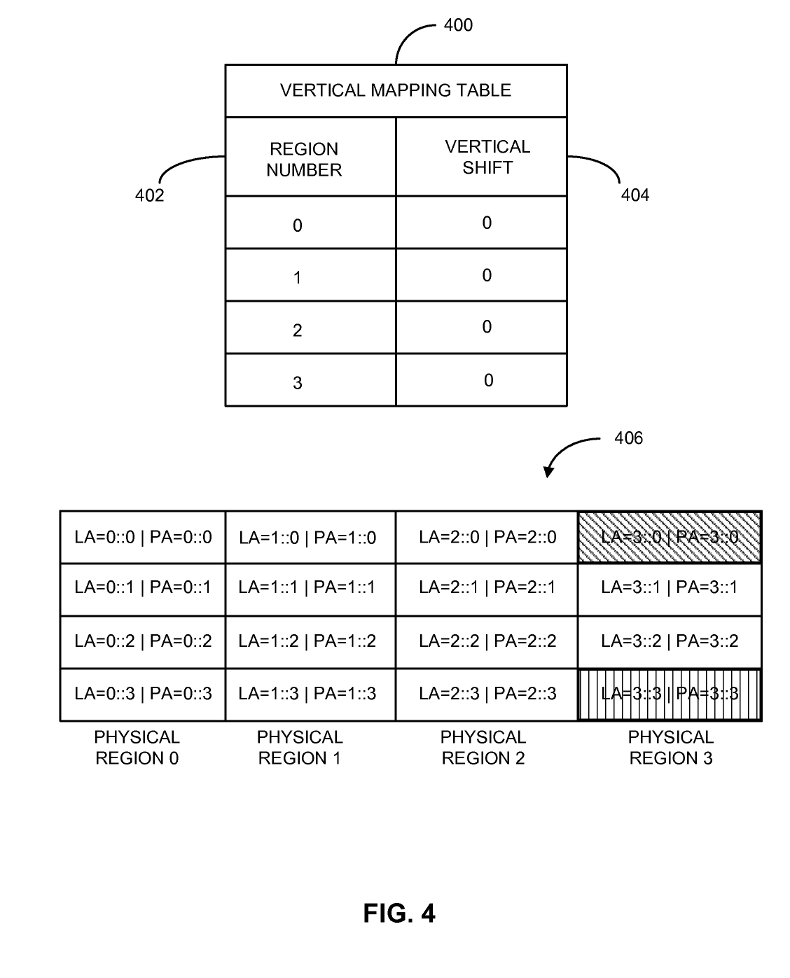

Referring now to FIG. 4, a vertical write level mapping table 400 and a diagram 406 illustrating the association of certain logical and physical addresses of a memory array prior to a vertical shift are illustrated. A vertical write level mapping table, such as vertical mapping table 400, may be included as part of the vertical and horizontal write level mapping tables 108 described above. The vertical mapping table 400 includes a region number column 402 and a vertical shift number column 404. The region number column 402 identifies all of the regions in a memory array, such as memory array 122 described above. The diagram 406 of FIG. 4 only illustrates four regions, each having four lines for purposes of simplicity, however, it is recognized that the concepts described herein apply equally well to a memory array having any suitable number of lines and regions.

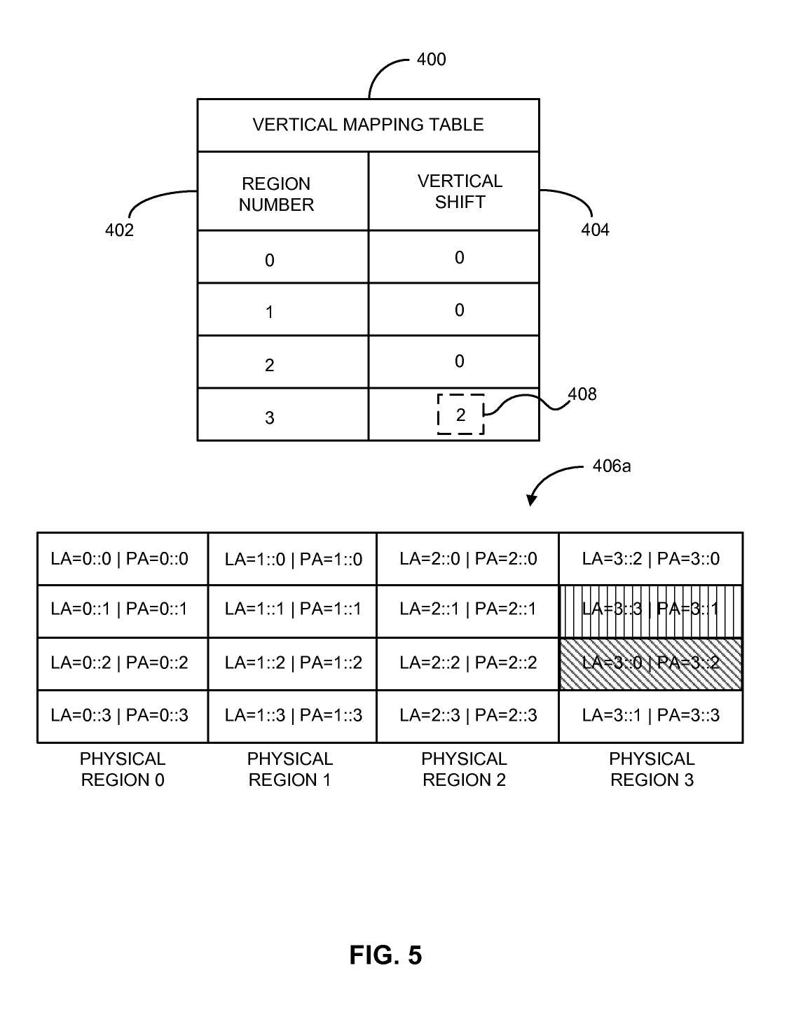

The vertical shift column 404 identifies how the association between certain logical addresses and physical addresses should change based upon a determination (e.g., by counter evaluation logic 116) that a particular region in the memory array has been written to a predetermined number of times (i.e., met or exceeded its corresponding threshold value). With continued reference to FIG. 4, vertical mapping table 400 is depicted in an initialization state without any vertical shift numbers assigned to any of the region numbers of the region number column 402. Of course, in certain embodiments, there may be vertical shift numbers assigned to any or all of the region numbers during initialization as a matter of design choice. In any event, diagram 406 depicts the association of logical addresses to physical addresses for four different physical regions of a memory array (i.e., physical regions 0-3). For example, with reference to the cell in the upper right-hand corner of diagram 406, the cell notes “LA=3::0|PA=3::0”. This is intended to demonstrate that, in this state, the logical address (“LA”) at region (3) and line (0) (“3::0”) is associated with the physical address (“PA”) at region (3) and line (0) (“3::0”). In order to trace the re-mapping (i.e., re-association) of certain logical addresses, the cell corresponding to logical address 3::0 is illustrated as having a diagonal cross-hatch in both FIGS. 4-5. By contrast, and with reference to the cell in the lower right-hand corner of diagram 406, the cell notes “LA=3::3|PA=3::3”. This is intended to demonstrate that, in this state, the logical address (“LA”) at region (3) and line (3) (“3::3”) is associated with the physical address (“PA”) at region (3) and line (3) (“3::3”). The cell corresponding to logical address 3::3 is illustrated as having a vertical cross-hatch in both FIGS. 4-5.

FIG. 5 generally depicts an updated version of the vertical mapping table 400 of FIG. 4 and a diagram 406a illustrating an updated association between certain logical and physical addresses of a memory array following a vertical shift. For example, the vertical mapping table 400 and diagram 406 of FIG. 4 may be thought of as corresponding to an initial state of the apparatus 100, before the amount of resistance stored in any PVRM based write counter exceeds its corresponding threshold value (as determined, for example, by the counter evaluation logic 116). Conversely, the vertical mapping table 400 and diagram 406a of FIG. 5 may be thought of as corresponding to a subsequent state of the apparatus 100, following a determination that the amount of resistance stored in a PVRM based region write counter exceeds its corresponding threshold value.

The updated mapping table 400 and diagram 406a depicted in FIG. 5 can be arrived at from the mapping table 400 and diagram 406 shown in FIG. 4 in the following manner. As discussed above, FIG. 4 illustrates an initialization state in order to show how the present apparatus 100 may re-map certain logical addresses to different physical addresses in order to perform wear-leveling and mitigate adversarial attacks. Thus, in order to simplify the discussion, consider an example where the apparatus 100 is a computing device including a memory array 122 that has not been written to.

Accordingly, at this stage (and by way of example only) each incoming logical address may be associated with the exact same physical address via the vertical and horizontal write level mapping tables 108. That is to say, at this stage, all of the vertical shift numbers corresponding to each of the region numbers shown in the vertical mapping table 400 would be zero (as is the case in FIG. 4). This is the situation shown in FIG. 4.

Eventually, a given physical region of the memory array will be written to enough times that it will reach its threshold (as determined, for example, by the counter evaluation logic 116 in accordance with its above-described functionality). When a given region (e.g., region (3)) has been written to enough times to meet or exceed the threshold value associated with that region, the apparatus 100 is operative to change the association between all logical address associated with that physical region. This concept is best illustrated with respect to FIG. 5.

FIG. 5 illustrates an exemplary situation where region (3) had been written to enough times to meet or exceed the threshold value associated with that region (i.e., the aggregate number of writes to each physical address within region (3) exceeded the threshold value associated with region (3)). Accordingly, mapping table update logic 114 generated mapping table(s) update information 156 operative to update vertical mapping table 400. Specifically, the mapping table(s) update information 156 updated the vertical mapping table 400 to change the vertical shift number 408 associated with region (3) from zero to two. This has the effect of changing the association of all logical and physical addresses at region (3). Specifically, by changing the vertical shift number 408 associated with region (3) from zero to two, each logical address at region (3) becomes associated with a different physical address at region (3).

For example, logical address 3::0 was originally associated with physical address 3::0 as shown in FIG. 4. However, following the mapping table update, logical address 3::0 becomes associated with physical address 3::2 as shown in FIG. 5. Similarly, logical address 3::3 was originally associated with physical address 3::3 as shown in FIG. 4. However, following the mapping table update, logical address 3::3 becomes associated with physical address 3::1 as shown in FIG. 5. Thus, as shown in FIG. 5, each logical address corresponding to region (3) has been remapped to a physical address two lines over from its original mapping. The vertical shift number 408 describes how many lines over (within the same region) the new physical address associated with each logical address at region (3) should be. While the vertical shift number 408 associated with region (3) is illustrated as being two in FIG. 5, it is appreciated that this number (and thus, the distance of the “shift”) may be selected as desired. For example, in one embodiment, the vertical shift number for any region may be one rather than two (meaning that each logical address would become associated with a physical address having the same region number, but one line over). Additionally, in one example, the vertical shift number may be incremented each time that it is determined that the appropriate region (i.e., all of the physical addresses within the appropriate region) has been written to the threshold number of times.

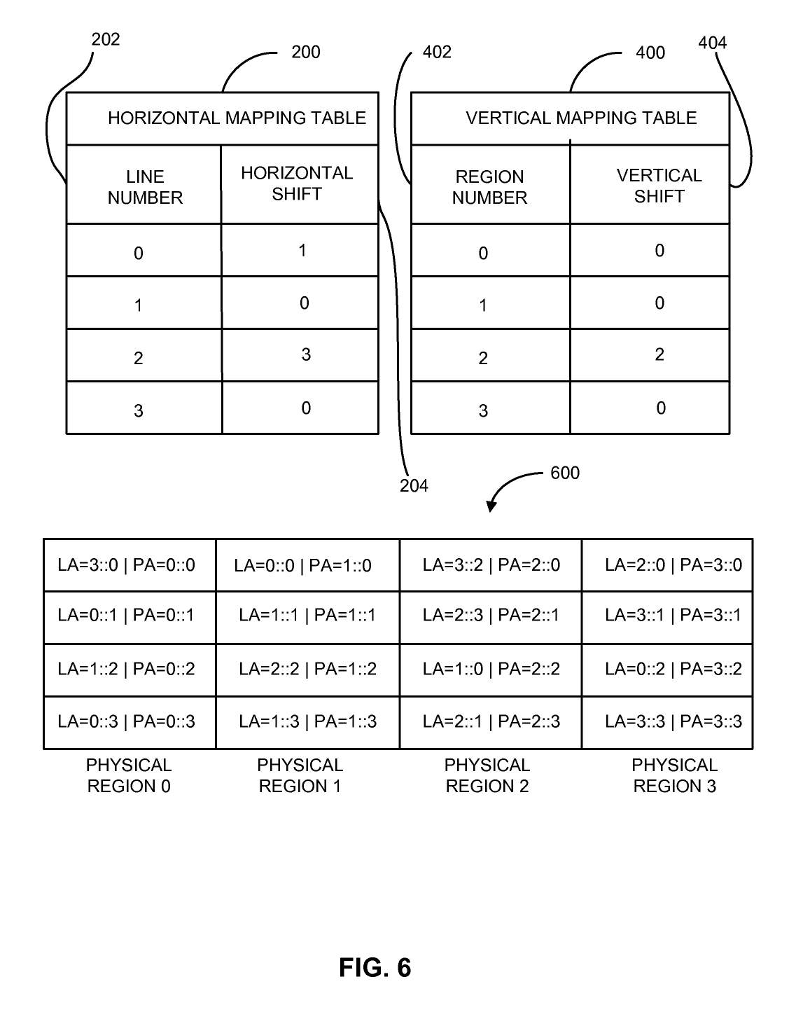

Referring now to FIG. 6, a horizontal mapping table 200 and vertical mapping table 400 are both provided. Diagram 600 shows the logical and physical address association following the execution of both a horizontal and vertical shift from an initialization stage (i.e., where all of the horizontal and vertical shift numbers were zero). FIG. 6 illustrates the concept that, in one example, the apparatus 100 of the present disclosure is operative to perform both horizontal and vertical shifts. For example, a horizontal shift may be carried out following a determination that the amount of resistance stored in a PVRM based line write counter (e.g., line (N) PVRM based write counter 136) exceeds the predetermined threshold value 120. Similarly, a vertical shift may be carried out following a determination that the amount of resistance stored in a PVRM based region write counter (e.g., region (N) PVRM based write counter 134) exceeds a predetermined threshold value 120. As an example of how the shifts affect the association between a given logical address and physical address, please refer to the top cell of physical region 2 corresponding to logical address 3::2 and physical address 2::0.

As can be seen, logical address 3::2 was associated with physical address 3::2 prior to the horizontal and vertical shifts. As an aside, the functionality of the apparatus 100 of the present disclosure is not affected if the horizontal shift is carried out before the vertical shift, or vice versa. In any event, starting with the horizontal mapping table 200, all of the logical address along line number (2) are shifted horizontally over three regions (again, the shifts are depicted as being carried out in a rightward fashion but could be carried out in a leftward fashion suitably well). Accordingly, at this stage, logical address 3::2 would be associated with physical address 2::2. Now, giving effect to the vertical mapping table 400, all of the logical addresses in region number two are shifted vertically up two lines (again, upward in this example, but a downward shift would work equally well). As such, logical address 3::2 becomes associated with physical address 2::0.

By shifting the association between logical and physical addresses as described in the manner set forth above, the present disclosure can perform wear-leveling and protect against adversarial attacks. For example, in order to perform wear-leveling, the threshold values for the PVRM based write counters can be set low enough that the threshold for any physical address will be met before the physical address becomes unreliable from excessive write operations. Adversarial programs have been known to target particular logical addresses and bombard the targeted addresses with write operation after write operation in an effort to wear-out the physical address associated with the targeted logical address. By changing the association between the logical addresses and physical addresses before any physical address wears out, adversarial programs have an extremely difficult time maintaining the association between the logical and physical addresses, and are therefore unable to wear-out their targeted section of the memory array.

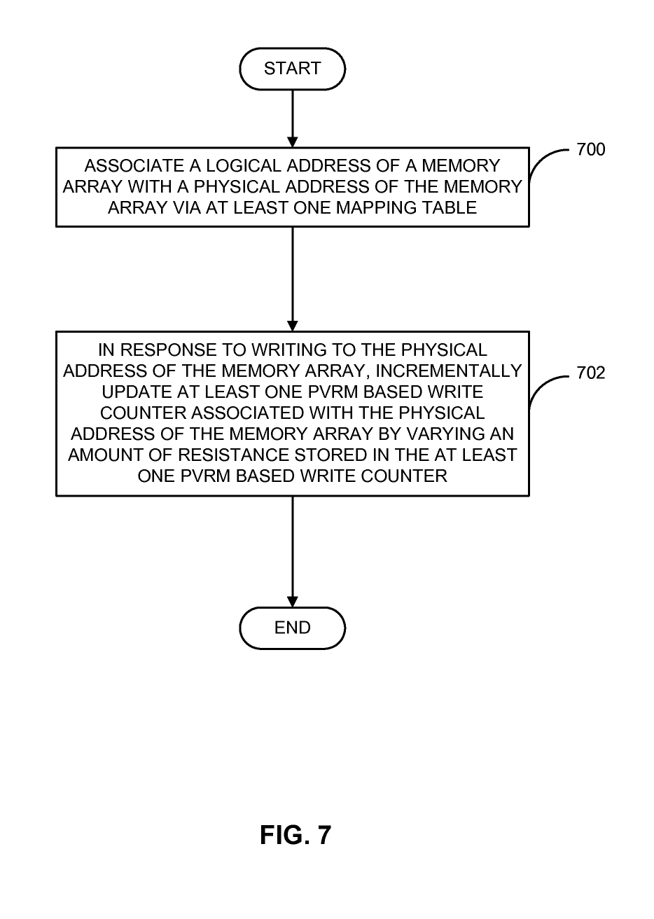

FIG. 7 is a flowchart illustrating one example of a method for performing memory wear-leveling using passive variable resistive (PVRM) based write counter in accordance with the present disclosure. The method disclosed in FIG. 7 may be carried out, for example, by the apparatus 100 described above. At step 700, a logical address of a memory array is associated with a physical address of the memory array via at least one mapping table. At step 702, in response to writing to the physical address of the memory array, at least one PVRM based write counter associated with the physical address of the memory array is incrementally updated. This incremental update may be accomplished, for example, by varying an amount of resistance stored in the at least one PVRM based write counter.

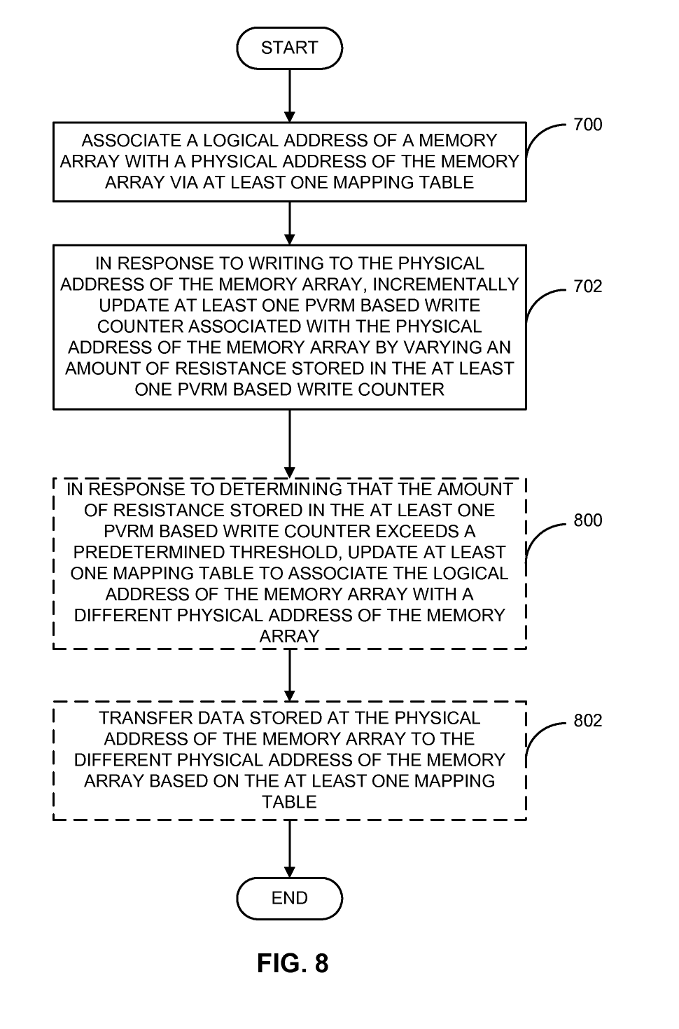

FIG. 8 is a flowchart illustrating another example of a method for performing memory wear-leveling using passive variable resistive (PVRM) based write counter in accordance with the present disclosure. Steps 700-702 are carried out in accordance with the discussion of those steps provided above. At step 800, in response to determining that the amount of resistance stored in the at least one PVRM based write counter exceeds a predetermined threshold, at least one mapping table is updated. Updating the at least one mapping table (e.g., the vertical and/or horizontal write level mapping tables) includes associating the logical address of the memory array with a different physical address of the memory array. At step 802, data stored at the physical address of the memory array is transferred to the different physical address of the memory array based on the at least one mapping table.

In one example, each PVRM memory cell (e.g., 1 bit) may be a memristor of any suitable design. Since a memristor includes a memory region (e.g., a layer of TiO₂) between two metal contacts (e.g., platinum wires), memristors could be accessed in a cross point array style (i.e., crossed-wire pairs) with alternating current to non-destructively read out the resistance of each memory cell. A crossbar is an array of memory regions that can connect each wire in one set of parallel wires to every member of a second set of parallel wires that intersects the first set (usually the two sets of wires are perpendicular to each other, but this is not a necessary condition). The memristor disclosed herein may be fabricated using a wide range of material deposition and processing techniques. One example is disclosed in U.S. Patent Application Publication No. 2008/0090337 entitled “ELECTRICALLY ACTUATED SWITCH.”

In this example, first, a lower electrode is fabricated using conventional techniques such as photolithography or electron beam lithography, or by more advanced techniques, such as imprint lithography. This may be, for example, a bottom wire of a crossed-wire pair. The material of the lower electrode may be either metal or semiconductor material, preferably, platinum.

In this example, the next component of the memristor to be fabricated is the non-covalent interface layer, and may be omitted if greater mechanical strength is required, at the expense of slower switching at higher applied voltages. In this case, a layer of some inert material is deposited. This could be a molecular monolayer formed by a Langmuir-Blodgett (LB) process or it could be a self-assembled monolayer (SAM). In general, this interface layer may form only weak van der Waals-type bonds to the lower electrode and a primary layer of the memory region. Alternatively, this interface layer may be a thin layer of ice deposited onto a cooled substrate. The material to form the ice may be an inert gas such as argon, or it could be a species such as CO₂. In this case, the ice is a sacrificial layer that prevents strong chemical bonding between the lower electrode and the primary layer, and is lost from the system by heating the substrate later in the processing sequence to sublime the ice away. One skilled in this art can easily conceive of other ways to form weakly bonded interfaces between the lower electrode and the primary layer.

Next, the material for the primary layer is deposited. This can be done by a wide variety of conventional physical and chemical techniques, including evaporation from a Knudsen cell, electron beam evaporation from a crucible, sputtering from a target, or various forms of chemical vapor or beam growth from reactive precursors. The film may be in the range from 1 to 30 nanometers (nm) thick, and it may be grown to be free of dopants. Depending on the thickness of the primary layer, it may be nanocrystalline, nanoporous or amorphous in order to increase the speed with which ions can drift in the material to achieve doping by ion injection or undoping by ion ejection from the primary layer. Appropriate growth conditions, such as deposition speed and substrate temperature, may be chosen to achieve the chemical composition and local atomic structure desired for this initially insulating or low conductivity primary layer.

The next layer is a dopant source layer, or a secondary layer, for the primary layer, which may also be deposited by any of the techniques mentioned above. This material is chosen to provide the appropriate doping species for the primary layer. This secondary layer is chosen to be chemically compatible with the primary layer, e.g., the two materials should not react chemically and irreversibly with each other to form a third material. One example of a pair of materials that can be used as the primary and secondary layers is TiO₂ and TiO₂₋ₓ, respectively. TiO₂ is a semiconductor with an approximately 3.2 eV bandgap. It is also a weak ionic conductor. A thin film of TiO₂ creates the tunnel barrier, and the TiO₂₋ₓ forms an ideal source of oxygen vacancies to dope the TiO₂ and make it conductive.

Finally, the upper electrode is fabricated on top of the secondary layer in a manner similar to which the lower electrode was created. This may be, for example, a top wire of a crossed-wire pair. The material of the lower electrode may be either metal or semiconductor material, preferably, platinum. If the memory cell is in a cross point array style, an etching process may be necessary to remove the deposited memory region material that is not under the top wires in order to isolate the memory cell. It is understood, however, that any other suitable material deposition and processing techniques may be used to fabricate memristors for the passive variable-resistive memory.

Among other advantages, the present disclosure provides a method and apparatus for performing wear-leveling using passive variable resistive (PVRM) based write counters capable of measuring the number of writes to both a region and a line within a memory array. Furthermore, the analog nature of the PVRM write counters allows for a single PVRM cell (e.g., a memristor cell) to serve as a multi-bit counter for tracking the amount of wear to a line/region of a memory array. By tracking the wear a memory array with such fine granularity, mapping shifts may be performed when they are actually needed (as opposed to when they are thought to be needed based upon a statistical estimation) in order to both (1) evenly distribute wear across the memory array and (2) protect against adversarial programs that attempt to wear out a memory array. Additionally, new techniques for mapping logical addresses to physical addresses are provided. Other advantages will be recognized by those of ordinary skill in the art.

Also, integrated circuit design systems (e.g., workstations) are known that create integrated circuits based on executable instructions stored on a computer readable memory such as but not limited to CD-ROM, RAM, other forms of ROM, hard drives, distributed memory, etc. The instructions may be represented by any suitable language such as but not limited to hardware descriptor language or any other suitable language. As such, the apparatus described herein may also be produced as integrated circuits by such systems. For example, an integrated circuit may be created using instructions stored on a computer readable medium that when executed cause the integrated circuit design system to create an integrated circuit that is operative to associate a logical address of a memory array with a physical address of the memory array via at least one mapping table; and in response to writing to the physical address of the memory array, incrementally updating at least one PVRM based write counter associated with the physical address of the memory array by varying an amount of resistance stored in the at least one PVRM based write counter. Integrated circuits having logic that performs other operations described herein may also be suitably produced.

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. A method comprising:
associating a logical address of a memory array with a physical address of the memory array via at least one mapping table;
in response to writing to the physical address of the memory array, incrementally updating at least one passive variable resistive memory (PVRM) based write counter associated with the physical address of the memory array by varying an amount of resistance stored in the at least one PVRM based write counter.

2. The method of claim 1, wherein incrementally updating the at least one PVRM based write counter by varying the amount of resistance stored in the at least one PVRM based write counter comprises applying a current across the at least one PVRM based write counter.

3. The method of claim 1, wherein the at least one PVRM based write counter comprises a memristor cell.

4. The method of claim 1, further comprising:
in response to determining that the amount of resistance stored in the at least one PVRM based write counter exceeds a predetermined threshold, updating the at least one mapping table to associate the logical address of the memory array with a different physical address of the memory array.

5. The method of claim 4, wherein updating the at least one mapping table to associate the logical address of the memory array with the different physical address of the memory array comprises updating a horizontal mapping table.

6. The method of claim 5, wherein updating the horizontal mapping table comprises changing a region number of the physical address associated with the logical address to provide the different physical address.

7. The method of claim 4, wherein updating the at least one mapping table to associate the logical address of the memory array with the different physical address of the memory array comprises updating a vertical mapping table.

8. The method of claim 7, wherein updating the vertical mapping table comprises changing a line number of the physical address associated with the logical address to provide the different physical address.

9. The method of claim 4, further comprising:
transferring data stored at the physical address of the memory array to the different physical address of the memory array based on the at least one mapping table.

10. The method of claim 1, wherein the physical address of the memory array identifies a line within a region of the memory array, and wherein incrementally updating the at least one PVRM based write counter comprises updating at least one of a PVRM based line write counter and a PVRM based region write counter.

11. The method of claim 10, wherein the PVRM based line write counter indicates a number of previous writes to the line, and wherein the PVRM based region write counter indicates a number of previous writes to the region.

12. An apparatus comprising:
a memory array comprising a plurality of physical addresses, each physical address of the plurality of physical addresses associated with a different logical address of a plurality of logical addresses via at least one mapping table;
at least one passive variable resistive memory (PVRM) based write counter associated with at least one physical address of the plurality of physical addresses of the memory array and operative to store a varying amount of resistance, wherein the amount of resistance stored in the at least one PVRM based write counter indicates a number of previous writes to the at least one physical address; and
PVRM write counter update logic operatively connected to the memory array and the at least one PVRM based write counter, the PVRM write counter update logic operative to incrementally update the at least one PVRM based write counter in response to the at least one physical address being written to, by varying the amount of resistance stored in the at least one PVRM based write counter.

13. The apparatus of claim 12, wherein the memory array comprises the at least one PVRM based write counter.

14. The apparatus of claim 12, further comprising counter evaluation logic operatively connected to the memory array, the counter evaluation logic operative to determine whether the number of previous writes to the at least one physical address exceeds a predetermined threshold.

15. The apparatus of claim 14, wherein the counter evaluation logic is operative to determine whether the number of previous writes to the at least one physical address exceeds the predetermined threshold by comparing the amount of resistance stored in the at least one PVRM based write counter associated with the at least one physical address with a predetermined threshold value.

16. The apparatus of claim 15, wherein the counter evaluation logic further comprises at least one register, the at least one register operative to store the predetermined threshold value.

17. The apparatus of claim 14, further comprising mapping table update logic operatively connected to the counter evaluation logic, the mapping table update logic operative to update the at least one mapping table in response to a determination by the counter evaluation logic that the number of previous writes to the at least one physical address exceeds the predetermined threshold.

18. The apparatus of claim 17, wherein the mapping table update logic is operative to update the at least one mapping table by changing the physical address associated with a particular logical address.

19. The apparatus of claim 17, further comprising data transfer logic operatively connected to the memory array, the data transfer logic operative to instruct the memory array to transfer data stored at a first physical address of the plurality of physical addresses of the memory array to a second physical address of the plurality of physical addresses of the memory array based on the at least one mapping table.

20. The apparatus of claim 12, wherein each physical address of the memory array identifies a line of a plurality of lines within a region of the memory array, and wherein the at least one PVRM based write counter associated with the at least one physical address comprises at least one of a PVRM based line write counter and a PVRM based region write counter.

21. The apparatus of claim 20, wherein the PVRM based line write counter is operative to store a varying amount of resistance, wherein the amount of resistance stored in the PVRM based line write counter indicates a number of previous writes to the line at the at least one physical address that the PVRM based line write counter is associated with.

22. The apparatus of claim 20, wherein the PVRM based region write counter is operative to store a varying amount of resistance, wherein the amount of resistance stored in the PVRM based region write counter indicates a number of previous writes to all lines of the plurality of lines within the region including the at least one physical address that the PVRM based region write counter is associated with.

23. The apparatus of claim 12, wherein the at least one PVRM based write counter comprises a memristor cell.

24. An apparatus comprising:
a single memory cell operative to store a plurality of bits, wherein the plurality of bits indicate a physical address write-value, and wherein the physical address write-value indicates an amount of writes that have been performed to a physical address of a memory array.

25. An apparatus comprising:
a single multi-bit memory cell associated with a line within a region of a memory array, wherein the single multi-bit memory cell is operative to store a plurality of bits indicating a line write-value, and wherein the line write-value indicates an amount of writes that have been performed to the line associated with the single multi-bit memory cell.

26. The apparatus of claim 25, wherein the single multi-bit memory cell comprises a memristor.

27. An apparatus comprising:
a memory array comprising at least one region, each at least one region comprising a plurality of lines;
a first multi-bit memory cell associated with a line of the plurality of lines within a given region of the memory array, wherein the first multi-bit memory cell is operative to store a plurality of bits indicating a line write-value, and wherein the line write-value indicates an amount of writes that have been performed to the line associated with the first multi-bit memory cell; and
a second multi-bit memory cell associated with the at least one region of the memory array, wherein the second multi-bit memory cell is operative to store a plurality of bits indicating a region write-value, and wherein the region write-value indicates an amount of writes that have been performed to the at least one region associated with the second multi-bit memory cell.
